(19) United States
(12) Patent Application Publication
(10) Pub. No.: US 2015/0089670 A1
(43) Pub. Date: Mar. 26, 2015

(54) APPARATUS, SYSTEM AND METHOD FOR MANAGING ELECTRONIC CONTENT LICENSES

(71) Applicant: Yamaha Corporation, Hamamatsu-Shi (JP)

(72) Inventor: Takahiro YANAGAWA, Hamamatsu-Shi (JP)

(21) Appl. No.: 14/492,338

(22) Filed: Sep. 22, 2014

(30) Foreign Application Priority Data
Sep. 25, 2013 (JP) 2013-199074

(51) Int. Cl. G06F 21/10; H04L 29/06

(52) U.S. Cl. CPC G06F 21/10; H04L 63/10; G06F 2221/0713
USPC 726/28

(57) ABSTRACT

For a particular content item duly acquired by a user is registered user information including user identification information, content identification information and model information and apparatus ID of each apparatus authorized to use the content item. For a same model, the user can be granted an authorization to use the content item in a plurality of apparatus of different apparatus IDs. In requesting an additional authorization to use the content item in a new target apparatus, the user sends to a license manager a request including model information and an apparatus ID of the target apparatus. Even where the authorization to use the particular content item has already been granted to another apparatus of a given model up to a predetermined maximum usable number, a further authorization is grantable to the target apparatus of another model than the given model, taking into account the model information included in the request.

### FIELD OF THE INVENTION

The present invention relates to an electronic content licensing system which controls content item licenses to apparatus using electronic content (hereinafter referred to as “electronic-content using apparatus”) to allow the content items to be used properly

### BACKGROUND OF THE INVENTION

Heretofore, there have been known systems which or restrict or limit use, by electronic-content using apparatus, of content items. For example, in an electronic music content acquisition system disclosed in U.S. Patent Application Publication No. 2005/0149448 (hereinafter referred to as “Patent Literature 1”) corresponding to Japanese Patent Application Laid-open. Publication No. 2005-195901, a content acquisition apparatus is constructed to acquire desired music content from a content distribution site that distributes music content, such as music piece data sets, as content items and then embed in the acquired music content an apparatus ID (e.g., a part of an encryption key) of an electronic music apparatus that uses the music content. Thus, in the electronic music content acquisition system disclosed in Patent Literature 1, only the electronic music apparatus with the embedded apparatus ID is allowed to use the acquired music content, so that an unspecified large number of electronic-content using apparatus can be prevented from using the music content.

Further, in a content supply system disclosed, for example, in U.S. Patent Application Publication No. 2004/0064380 (hereinafter referred to as “Patent Literature 2”) corresponding to Japanese Patent Application Laid-open Publication No. 2004-117798, a server that supplies content, such as music piece data sets, as content items stores therein, per user, copy control data and content ID information of content already supplied to the user. Once a request for copying content already purchased by a user is received from a terminal of the user, the server sends to the user terminal the copy control data corresponding to the purchased content and thereby permits external equipment (electronic musical instrument) of the user terminal or the like to copy the purchased content up to a predetermined number of times. In this manner, the user-purchased content can be used by a plurality of pieces of external equipment etc. within the range of personal use, and the user-purchased content can also be prevented from being used by an unspecified large number of users.

Further, in “iTunes Store: Authorize or deauthorize your Mac or PC” (http://support.apple.com/kb/HT1420?viewlocale=en US) (hereinafter referred to as “Non-patent Literature 1”) discloses that, in the iTunes store, a user can authorize up to five its (his/her) computers using its Apple ID. In that case, if the user sells or gives away any of its computers, the user should deauthorize the computer. Namely, in the iTunes store, no distinction is made among the models of the user's computers, and up to five user's computers can be authorized regardless of the models of the user's computers. Thus, if the user wants to sell any one of the authorized computers, the user has to deauthorize that computer, which tends to be very cumbersome.

However, in the electronic music content acquisition system disclosed in Patent Literature 1, the electronic content (music content) cannot be used any loner if the apparatus ID changes, for example, by reason that the user replaces the electronic music apparatus, which is an electronic-content using apparatus, with another one or has the electronic music apparatus repaired. Further, in the content supply system disclosed in Patent Literature 2, although the supplied content item can be copied up to the predetermined number of times even after the apparatus H) changes, for example, by reason that the user replaces the external equipment (electronic musical instrument), which is an electronic-content using apparatus, with another one or has the external equipment repaired, the content item cannot be used any longer once the copying of the content item reaches the predetermined number of times due to repeated replacement and repair. With the iTunes store disclosed in Non-patent Literature 1, such inconveniences can be overcome by deauthorizing the computer, but considerable time and labor would be required for the deauthorization.

In recent electronic content usage, there is a tendency that a cycle in which hardware apparatus are changed over to their respective new models is getting shorter and shorter. Heretofore, when a user has changed its hardware apparatus over to a new model, there has been an inconvenience that considerable time and labor is required for deauthorizing the previous hardware apparatus, as disclosed in Patent Literature 1, in order to allow software or content item, having so far been used, to be used also in the hardware apparatus of the new model. However, such an inconvenience has not been clearly recognized, and thus, no attempt to solve the inconvenience has been made to this date.

### SUMMARY OF THE INVENTION

In view of the foregoing prior art problems, it is an object of the present invention to provide an improved technique for managing an electronic content license which can not only prevent unfair use of electronic content but also prevent electronic content from becoming unusable due to replacement or repair of an electronic-content using apparatus and which can readily dealing with a model change of a hardware apparatus.

In order to accomplish the above-mentioned object, the present invention provides an improved apparatus for managing an electronic content license, which comprises: a user information storage device which stores therein, as user information and for each of a plurality of users having acquired one or more content items, user identification information identifying the user, content identification information indicative of the one or more content items acquired by the user, model information indicating, for each of the one or more content items, models of one or more electronic-content using apparatus having been granted an authorization to use the content item, and apparatus IDs individually identifying the one or more electronic-content using apparatus, in association with one another; and a processor unit. The processor unit is configured to: receive from a user a request requesting an authorization for license) to use a particular content item, the request defining user identification information identifying the requesting user, content identification information indicative of the particular content item, model information indicative of a model of a target electronic-content using apparatus where the user wants to use the particular content item (i.e., request-target electronic-content using apparatus) and apparatus ID of the target electronic-content using apparatus; compare the information defined by the request with the user information stored in the user information storage device and thereby identify, from among the user information stored in the user information storage device, particular user information of which the user identification information, the content identification information and the model information matches the request but the apparatus ID does not match the request; and if the number of the apparatus IDs associated with the identified particular user information is equal to or smaller than a predetermined number, authorize use of the particular content item in the request-target electronic-content using apparatus.

According to the present invention, if the total number of different apparatus IDs registered as the user information for the same model of the request-target electronic-content using apparatus, where the user wants to use the particular content, is equal to or smaller than a predetermined number (i.e., less than a predetermined maximum usable number), namely, if the total number of electronic-content using apparatus of the same model possessed by the user and duly authorized (licensed) to use the particular content item is equal to or smaller than the predetermined number, then an authorization to use the particular content is also granted to the request-target electronic-content using apparatus. For example, if the maximum usable number is “5” (five), the predetermined number is set at “4” (four). Thus, the user is allowed to use the particular content item in as many electronic-content using apparatus of the same model as the predetermined maximum usable number. Namely, according to the present invention, restriction on the number of electronic-content using apparatus capable of using the particular content item duly possessed by the user (i.e., restriction on the number of copying of the particular content item) is applied to only electronic-content using apparatus of the same model. Thus, if a request defining model information of a new model other than the model already registered as the user information, a predetermined determination condition, i.e. “equal to or smaller than the predetermined number” can be satisfied naturally, and thus, a license or authorization to use the particular content is granted to the request-target electronic-content using apparatus of the new model specified by the request. Further, if not only the model information but also the apparatus ID of the request-target electronic-content using apparatus matches the user information already stored (registered) in the user information storage device, then the restriction on the number of electronic-content using apparatus capable of using the particular content item (i.e., the restriction on the number of copying of the particular content item) is not applied to the request-target electronic-content using apparatus.

Therefore, according to the present invention, the following advantageous benefits can be achieved.

(a) Even in a case where an electronic-content using apparatus has changed in apparatus ID due to repair or the like of the electronic-content using apparatus, or where a plurality of electronic-content using apparatus of a same model are possessed by a registered user, the user is allowed to use a desired content item as long as the number of the electronic-content using apparatus does not exceed the predetermined maximum usable number of electronic-content using apparatus (e.g., five electronic-content using apparatus).

(b) When the electronic-content using apparatus has been replaced with a different model, the user is allowed to use a desired content item regardless of the number of the electronic-content using apparatus of the model previously possessed by the user.

(c) Because, for each duly-acquired content item, the user information has stored therein user information where model information and apparatus ID of an electronic-content using apparatus that uses the content item are associated with content identification information and user identification information, the content item cannot be used in any electronic-content using apparatus that is not associated with the user identification information, i.e. that is not duly possessed by the user. Thus, the present invention can reliably prevent the content item from being unfairly used in an unspecified large number of electronic-content using apparatus.

(d) For the same model and same apparatus ID, a desired content item can be downloaded without restriction on the number of times of downloading. Thus, even in a case where once-downloaded electronic content (data) has broken, the electronic content can be re-downloaded at any desired time.

As a result, the present invention can reliably prevent unfair use of a content item and prevent a content item from becoming unusable due to replacement, repair or the like of an electronic-content using apparatus.

The present invention may be constructed and implemented not only as the apparatus invention discussed above but also as a method invention. Also, the present invention may be arranged and implemented as a software program for execution by a processor, such as a computer or DSP, as well as a non-transitory computer-readable storage medium storing such a software program. In this case, the program may be provided to a user in the storage medium and then installed into a computer of the user, or delivered from a server apparatus to a computer of a client via a communication network and then installed into the client's computer. Further, the processor used in the present invention may comprise a dedicated processor with dedicated logic built in hardware, not to mention a computer or other general-purpose processor capable of running a desired software program.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will hereinafter be described in detail, by way of example only, with reference to the accompanying drawings, in which:

FIG. 1 is a block diagram outlining an example overall construction of one embodiment of a electronic content license system of the present invention;

FIG. 2 is a block diagram showing an example hardware setup of each of information processing apparatus constituting the embodiment of the electronic content license system of the present invention;

FIG. 3 is a diagram showing an example of user information stored in the electronic content license apparatus in the embodiment;

FIG. 4 is a flow chart showing a part of overall processing performed in the embodiment of the electronic content license system of the present invention;

FIG. 5 is a flow chart showing a remaining part of the overall processing performed in the embodiment of the electronic content license system of the present invention;

FIG. 6 is a flow chart showing an example operational sequence of a license determination process performed in the embodiment of the electronic content license system;

FIG. 7 is a block diagram explanatory of an example construction of another embodiment of the electronic content license system of the present invention;

FIG. 8 is a block diagram explanatory of an example construction of still another embodiment of the electronic content license system of the present invention; and

FIG. 9 is a conceptual diagram explanatory of an alternative form of storage of the user information.

### DETAILED DESCRIPTION OF THE INVENTION

Now, a description will be given about embodiments of an electronic content license system of the present invention. It should be appreciated that the present invention can be modified variously without being limited to the embodiments described herein.

[Outline of the Electronic Content License System]

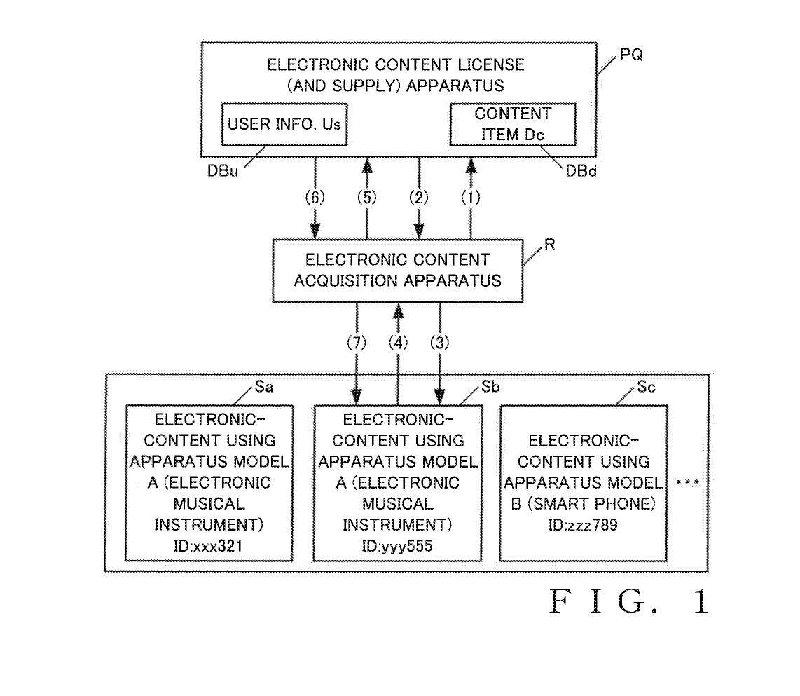

FIG. 1 is a block diagram outlining an example overall construction of a first embodiment of the electronic content license system of the present invention. In the illustrated example of FIG. 1, the electronic content license system comprises: an electronic content supply and license management apparatus (hereinafter also referred to simply as “electronic content license apparatus”, “supply and license apparatus” or “license apparatus”) PQ; an electronic content acquisition apparatus (hereinafter also referred to as “acquisition apparatus”) R; and a plurality of electronic-content using apparatus (hereinafter also referred to as “electronic-content using equipment”, or simply as “using apparatus” or “using equipment”) Sa, Sb, Sc, . . . . The electronic content license apparatus PQ includes a user information database (user information storage device) DBu cumulatively storing and managing respective user information Us of a plurality of users, and an electronic content database DBd cumulatively storing and managing a plurality of content items Dc. Thus, the electronic content license apparatus PQ functions also as an electronic content supply apparatus (electronic content selling server) that supplies content items Dc to clients. Note that the plurality of electronic-content using apparatus Sa, Sb, Sc, . . . will sometimes be indicated by reference character “S”.

The electronic content license apparatus PQ and the electronic content acquisition apparatus R can communicate with each other in a wired or wireless fashion. The electronic content license apparatus PQ has not only a function of, as an electronic content supply apparatus, transmitting a given content item Dc, requested from the electronic content acquisition apparatus R, to the electronic content acquisition apparatus R, but also a license control function of determining whether or not to grant a license or authorization regarding use of the transmitted content item Dc. For such purposes, the user information database DBu has stored therein, as user information Us and for each individual one of a plurality of users having duly purchased one or more content items Dc, user identification information identifying the user, content identification information identifying each of the one or more content items duly purchased by the user, model information indicative, for each of the one or more content items Dc, models of one or more electronic-content using apparatus S authorized to use the content item and apparatus IDs individually identifying the one or more electronic-content using apparatus S, in association with one another.

The electronic content acquisition apparatus R is in the form of a general-purpose information processing apparatus, such as a personal computer or a tablet computer, and as a client of the electronic content license apparatus PQ, the electronic content acquisition apparatus R has a function of communicating with the electronic content license apparatus PQ. Further, the electronic content acquisition apparatus R and the electronic-content using apparatus S (Sa, Sb, Sc, . . . ) can communicate with each other either via a wired or wireless communication network or via a detachable portable storage medium. In FIG. 1, it is assumed that the electronic-content using apparatus Sa, Sb, Sc, . . . are used by a same user (e.g., user A) as the electronic content acquisition apparatus R, and illustration of electronic content acquisition apparatus R and electronic-content using apparatus S used by other users is omitted for simplicity.

As the electronic-content using apparatus S are used, for example, dedicated apparatus, such as electronic musical instruments, musical score display apparatus, portable phones, music players, motion picture players, electronic book readers and navigation apparatus, and general-purpose electronic apparatus, such as smart phones. In FIG. 1, three electronic-content using apparatus Sa to Sc are shown in some detail as the electronic-content using apparatus S possessed by user A. In the illustrated example of FIG. 1, the electronic-content using apparatus Sa is an electronic musical instrument of model A and has an apparatus ID “xxx321”, the electronic-content using apparatus Sb is also an electronic musical instrument of model A and has an apparatus ID “yyy555”, and the electronic-content using apparatus Sc is a smart phone of model B and has an apparatus ID “zzz789”.

Content items Dc handled in the instant embodiment of the electronic content license system include various kinds of content items, such as electronic content and application programs, which are electronically distributed and can be used in the electronic-content using apparatus Sa, Sb, Sc, . . . . Among examples of such electronic content are performance data, performance supplementing data (e.g., registration data and accompaniment style data), tone color data, musical score data, ringing tone data, music data, image data, motion picture data, text data and map data.

The instant embodiment of the electronic content license system operates in accordance with procedures (1) to (7) as set forth below. The electronic content supply and license management apparatus PQ supplies the electronic content acquisition apparatus R with a desired content item Dc which a user (e.g., user A) of the electronic content acquisition apparatus R wants to purchase. Then, once the electronic content supply and license management apparatus PQ determines, with reference to the user information database DBu, that the user satisfies a predetermined condition, it authorizes the user to use the content item Dc supplied to the acquisition apparatus R, so that the user can use the desired content item in a desired electronic-content using apparatus S (using apparatus Sb in the illustrated example).

(1) The user (e.g., user A) performs an operation for accessing the electronic content supply and license management apparatus PQ via the electronic content acquisition apparatus R. The electronic content acquisition apparatus R transmits user identification information, such as a name and ID, of the user to the supply and license apparatus PQ, so that the supply and license apparatus PQ inputs (registers) the user identification information to the database DBu to thereby register the user. Then, once the user specifies a content item Dc to be purchased and performs a predetermined purchase process via the electronic content acquisition apparatus R, the supply and license apparatus PQ records content identification information, such as a name and ID, of the specified content item Dc into the user information database DBu in association with the user identification information and thereby registers that the user has duly purchased the content item Dc.

(2) Then, the supply and license apparatus PQ encrypts the content item Dc by use of the user identification information, such as the user ID, and then transmits the thus-encrypted content item Dc to the electronic content acquisition apparatus R. Then, the electronic content acquisition apparatus R receives and acquires the content item Dc and stores the acquired content item Dc into a storage device.

(3) Then, the user performs, on the electronic content acquisition apparatus R, an operation for sending the stored acquired content item Dc to the desired electronic-content using apparatus S (using apparatus Sb in the illustrated example) and using the content item Dc in the electronic-content using apparatus S. In the case where the electronic content acquisition apparatus R and the electronic-content using apparatus S are interconnected in a wired or wireless fashion, the acquisition apparatus R requests the using apparatus S for model information indicative of the model (type) and the apparatus ID of the using apparatus S. Further, in the case where the electronic content acquisition apparatus R and the electronic-content using apparatus S are not interconnected in a wired or wireless fashion, the acquisition apparatus R presents to the user (e.g., user A), via a display section or an audio output section of the acquisition apparatus R, prompting information acquisition via a detachable storage medium, such as an instructing message “Attach a storage medium storing the model and apparatus ID information”, in such a manner that the model information and apparatus ID can be acquired via the detachable storage medium.

(4) In the case where the electronic content acquisition apparatus R and the electronic-content using apparatus S are interconnected in a wired or wireless fashion, the electronic-content using apparatus S returns the model information and apparatus ID of the using apparatus S (in the case of the electronic-content using apparatus Sb, the model information=“electronic musical instrument A”, and the apparatus ID=“yyy555”). In the case where the electronic content acquisition apparatus R and the electronic-content using apparatus S are not interconnected in a wired or wireless fashion, on the other hand, the user attaches the detachable storage medium to the electronic-content using apparatus S and performs an operation for writing the model information and apparatus ID of the using apparatus S so that these information is written into the storage medium as a file. Then, the detachable storage medium is attached to the electronic content acquisition apparatus R, so that the above-mentioned information written in the storage medium is read into a RAM of the acquisition apparatus R.

(5) The user can use the electronic content acquisition apparatus R to request a license or authorization to use a particular content item Dc, and such a request is transmitted to and received by the electronic content license apparatus PQ. The request defines: user identification information identifying the requesting user; content identification information indicative of the particular content item; model information indicative of the model of the electronic-content using apparatus S (e.g., using apparatus Sb) (hereinafter referred to as “target electronic-content using apparatus” or “request-target electronic-content using apparatus”); and the apparatus ID of the target electronic-content using apparatus.

(6) Then, the electronic content license apparatus PQ determines (i.e., makes a license determination as to) whether or not the requesting user should be licensed or authorized to use the particular content item Dc, and it notifies the electronic content acquisition apparatus R of a result of the license determination. Namely, in the license determination, the license apparatus PQ compares and collates between the content identification information, model information and apparatus IDs contained in or associated with the user information Us registered for the requesting user (e.g., user A), having requested the license or authorization to use the content item Dc, and the information (content identification information, model information and apparatus ID) transmitted or included in the request, and the license apparatus PQ checks how many electronic-content using apparatus S of the same type (model) have already been registered by the requesting user. If the number of the electronic-content using apparatus S already registered by the requesting user is equal to or less than five, the license apparatus PQ determines that the user duly possesses the electronic-content using apparatus S of the same type (e.g., electronic musical instruments A) (or that the user might have replaced a substrate of some of the using apparatus S due to malfunction or the like) and that an authorization to use the content item Dc is grantable, and it issues a “grantable” message. Thus, the license apparatus PQ not only grants to the acquisition apparatus R an authorization to use the particular content item Dc but also registers the model information and apparatus ID of the using apparatus S (e.g., electronic-content using apparatus Sb), which has been authorized to use the content item Dc, into the user information database DBu, as user information Us corresponding to the user and content item Dc; that is, the license apparatus PQ updates the user information database DBu with the model information and apparatus ID of the request-target electronic-content using apparatus S. If, on the other hand, the user request a license or authorization to use the particular content item Dc in an electronic-content using apparatus S beyond the predetermined number, the electronic content license apparatus PQ regards the request as constituting unfair use, and thus, it determines that the authorization to use the content item Dc is non-grantable and issues a “non-grantable” message.

(7) Upon receipt of the license or authorization from the electronic content license apparatus PQ, the electronic content acquisition apparatus R decrypts the content item Dc by use of the user identification information, such as the user ID, then re-encrypts the content item Dc by use of the apparatus ID and then sends the thus-re-encrypted content item Dc to the electronic-content using apparatus S (e.g., using apparatus Sb). In the case where the acquisition apparatus R and the using apparatus S are interconnected in a wired or wireless fashion, the re-encrypted content item Dc is sent to the using apparatus S in a wired or wireless fashion. In the case where the acquisition apparatus R and the using apparatus S are not interconnected in a wired or wireless fashion, on the other hand, the re-encrypted content item Dc, is written into a detachable storage medium, and the detachable storage medium is attached to the using apparatus S so that the content item Dc is read from the storage medium into the using apparatus S. In case the “non-grantable” message is received from the license apparatus PG, the using apparatus S outputs a message “an authorization to use the content item Dc is non-grantable because the predetermined number of electronic-content using apparatus is exceeded” to the user through a display section 6 and 10 and/or an audio output section.

In the instant embodiment of the electronic content license system, as set forth above, the electronic content license apparatus PQ stores, in the user information database DBu, user identification information, content identification information indicative of each acquired content item Dc and model information and apparatus ID of each electronic-content using apparatus S which has already been licensed or authorized to use the content item Dc, in association with one another. Once an authorization to use a particular content item Dc is requested from a user (see procedure (5) above), the user identification information of the user, the content identification information indicative of the particular content item Dc and model information and apparatus ID of a target electronic-content using apparatus S in which the user wants to use the particular content item Dc are collated (compared) with the user information Us stored in the user information database DBu. If it has been determined, as a result of the collation (comparison), that the user identification information, the content identification information and the model information match the user information Us, the electronic content license apparatus PQ controls, in accordance with the number of the associated apparatus IDs, whether or not to output an authorization to use the particular content item. With such control, the authorization to use the particular content item is granted to up to a predetermined number of (e.g., five) different apparatus IDs of the electronic-content using apparatus S for the same user, same content item Dc and same model (type). However, if the total number of the apparatus IDs registered for the same model has reached the predetermined number, then the electronic content license apparatus PQ determines that the authorization to use the particular content item Dc is not grantable to any more electronic-content using apparatus S (see procedure (6) above).

[Hardware Setup of Individual Apparatus]

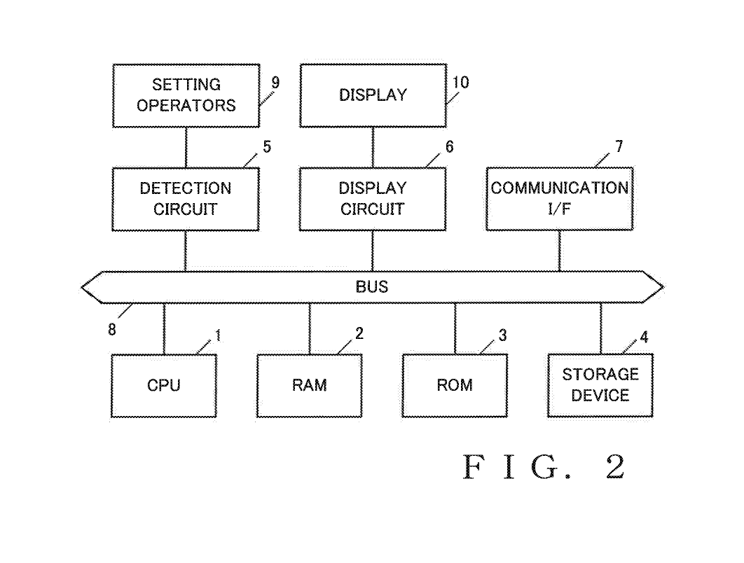

FIG. 2 is a block diagram showing an example hardware setup of each of the information processing apparatus constituting the embodiment of the electronic content license system of the present invention. Each of the information processing apparatus (i.e. the electronic content license apparatus PQ, the electronic content acquisition apparatus R and the electronic-content using apparatus S), constituting the embodiment of the electronic content license system, includes, as hardware structural components, a central processing unit (CPU or processor unit) 1, a random access memory (RAM) 2, a read-only memory (ROM) 3, a storage device 4, an operation detection circuit 5, a display circuit 6, a communication interface (I/F) 7, etc, and these components 1 to 7 are interconnected via a bus 8.

Each electronic-content using apparatus S in the form of an electronic musical instrument includes, in addition to the above, a performance operation section including a performance operator and an operation detection circuit for the performance operator, a tone generator (tone signal generation section) and an audio output section. Further, each electronic-content using apparatus S in the form of an audio or video reproduction play) apparatus includes, in addition to the above, an audio output section. Further, if the electronic content acquisition apparatus R is a general-purpose information processing terminal like a smart phone, it includes, in addition to the above, an audio output section and may employ or include a touch panel as necessary.

The CPU 1 that controls the entire information processing apparatus constitutes a data processing section in conjunction with the RAM 2 and the ROM 3 and performs various processes in accordance with various control programs. The RAM 2 is used to temporarily store or retain various necessary data at the time of the processes, and predetermined control programs and controlling data are prestored in the ROM 3.

The storage device 4 includes a storage medium, such as a hard disk (RD) or a flash memory, and a drive device for driving the storage medium. The storage medium may be built in the apparatus or detachably attachable to the apparatus like an external storage medium (e.g., memory card, USB memory or CD-R). Furthermore, various application programs and various data may be prestored in the storage device 4, and the user information database DBu and the electronic content database DBd are built in the electronic content license apparatus PQ.

The operation detection circuit 5 constitutes an input operation section in conjunction with setting operators 9, such as switches, and the operation detection circuit 5 detects operations performed on the setting operators 9 and outputs to a data processing section various information corresponding to the operations. The display circuit 6 constituters the display section in conjunction with a display (display device) 10, such as an LCD, and the display circuit 6 controls displayed content of the display 10 in accordance with an instruction given from the CPU 1 and provides assisting displays corresponding to various user operations. Note that functions of the setting operators 9 and the display 10 can be integrated together using a touch panel. Further, a message to a user can be given in video form via the display section 6 and 10, and, if there is an audio output section (not shown), the message to the user can also be given in voice or sound form via the audio output section.

Further, the communication I/F 7 includes a wired music I/F like the MIDI, a general-purpose network I/F like the USB, or a general-purpose short distance wireless I/F like a wireless LAN, and the communication I/F 7 is used to communicate with another information processing apparatus via a network CN. If the information processing apparatus constitutes the electronic content acquisition apparatus R or the electronic-content using apparatus S, storage equipment using a detachable storage medium (such as a memory card, USB memory or CD-R) may be provided as the storage device 4 so that the information processing apparatus can communicate information with the electronic content acquisition apparatus R or the electronic-content using apparatus S via the detachable storage medium.

[Example of User Information Stored in the Electronic Content License Apparatus]

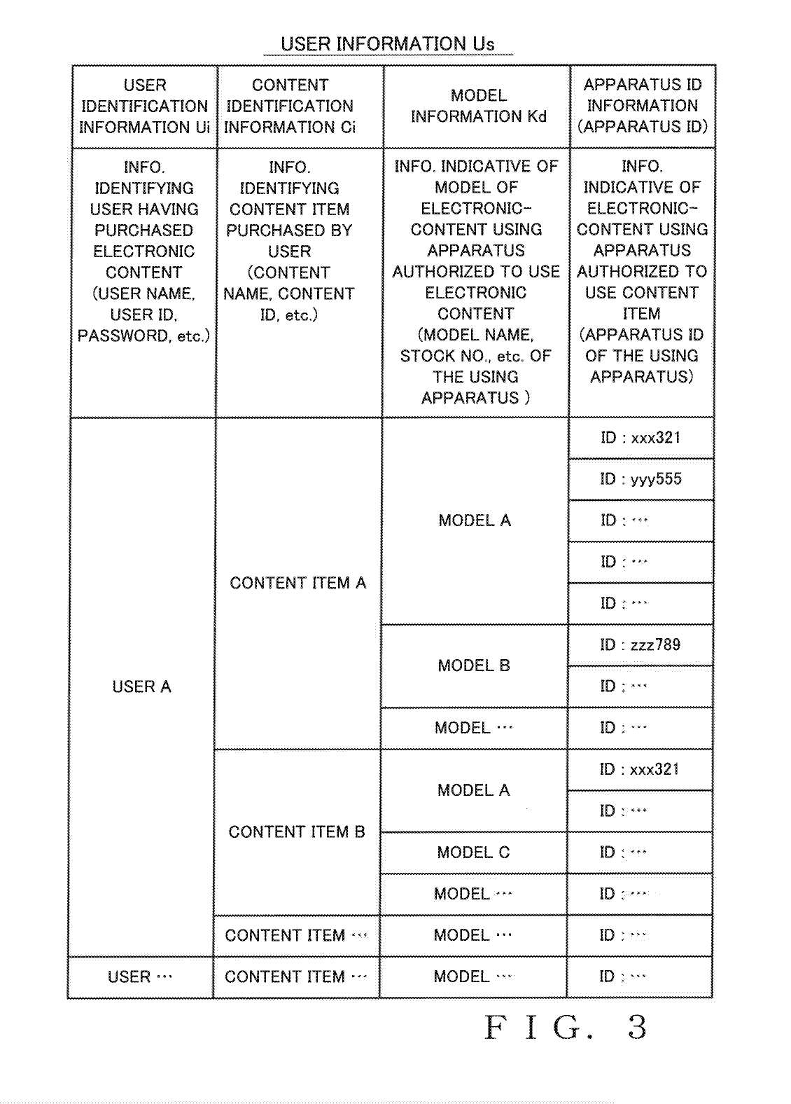

In the instant embodiment of the electronic content license system of the present invention, user information Us is stored for a plurality of users in the user information database DBu of the electronic content license apparatus, and the user information of the plurality of users is managed. FIG. 3 is a diagram showing an example of the user information stored in the electronic content license apparatus in the embodiment.

In the user information database DBu of the electronic content license apparatus PQ are stored (registered) user information Us of a plurality of users. More specifically, the user information Us includes, per user, user identification information Ui indicative of the user having performed the predetermined purchase procedure or process for purchasing (acquiring) one or more electronic contents Dc, content identification information Ci indicative of the content items Dc having been purchased (acquired) by the user, model information Kd indicative of models of electronic-content using apparatus S (Sa, Sb, Sc, . . . ) having been authorized to use the electronic contents Dc and apparatus ID information indicative of apparatus IDs of the electronic-content using apparatus S, which are stored (registered) in association with one another.

The user identification information Ui, which is used to identify a user having purchased an electronic content Dc, comprise a user's name (user name), a user's ID (user ID), a password, etc. The content identification information Ci, which is used to identify a content item having been purchased by the user, comprises a name of the content item Dc (electronic content name), an ID of the content item Dc (content item ID), etc. The model ID information Kd, which is used to identify a model (type) of electronic-content using apparatus S having been licensed or authorized to use the purchased content item Dc, comprises a name of the model (model name) and stock number of the electronic-content using apparatus S, etc. The apparatus ID information, which is used to identify the electronic-content using apparatus S having been authorized to use the purchased content item Dc, comprises an apparatus ID of the electronic-content using apparatus S.

Namely, in the user information Us, the user identification information indicative of the user name, user ID, password, etc, of each user and the content identification information indicative of each content item purchased by the user is registered, and the model ID information Kd and apparatus ID of each authorized electronic-content using apparatus S are registered in association with the content identification information Ci. The model ID information Kd and apparatus ID registered in association with the content identification information Ci are indicative of the model (Kd) and the apparatus ID of each electronic-content using apparatus S having been licensed or authorized to use the content items Dc indicated by the content identification information Ci. One or more models (Kd) (there is no upper limit in the number of the models) can be associated with each one of the content items Dc (content identification information Ci). One or more apparatus IDs (there is an upper limit in the number of the apparatus IDs, e.g., up to five apparatus IDs) can be registered per model (model information Kd).

[Example Behavior]

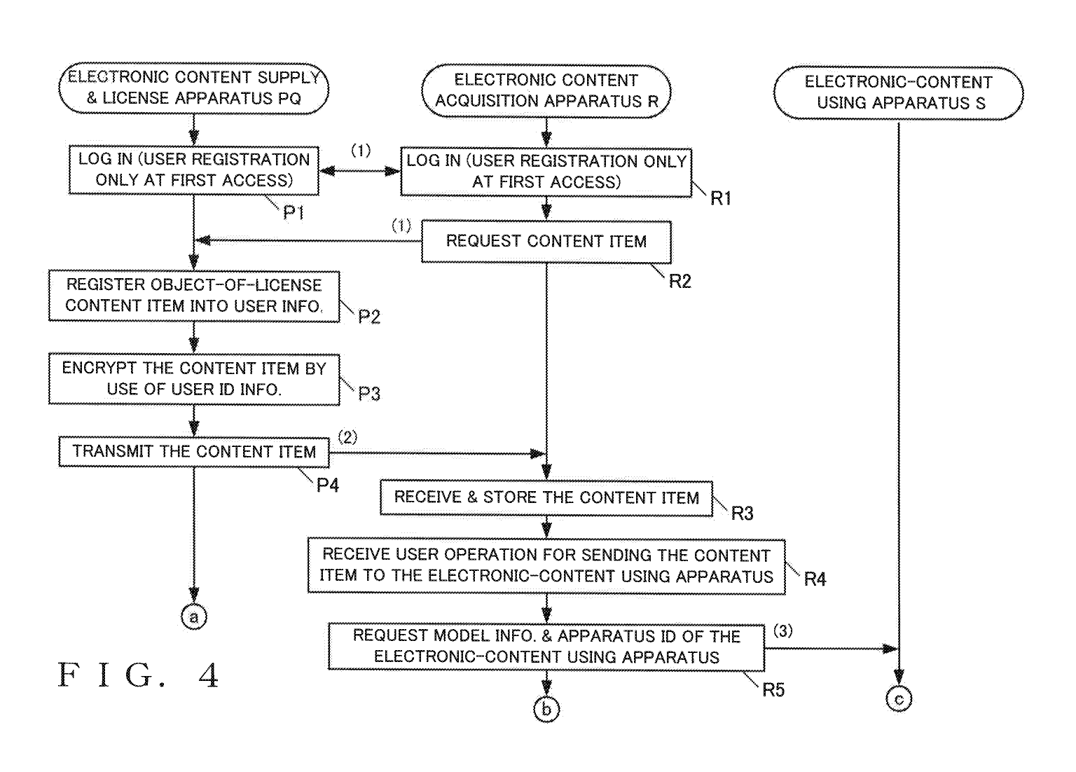

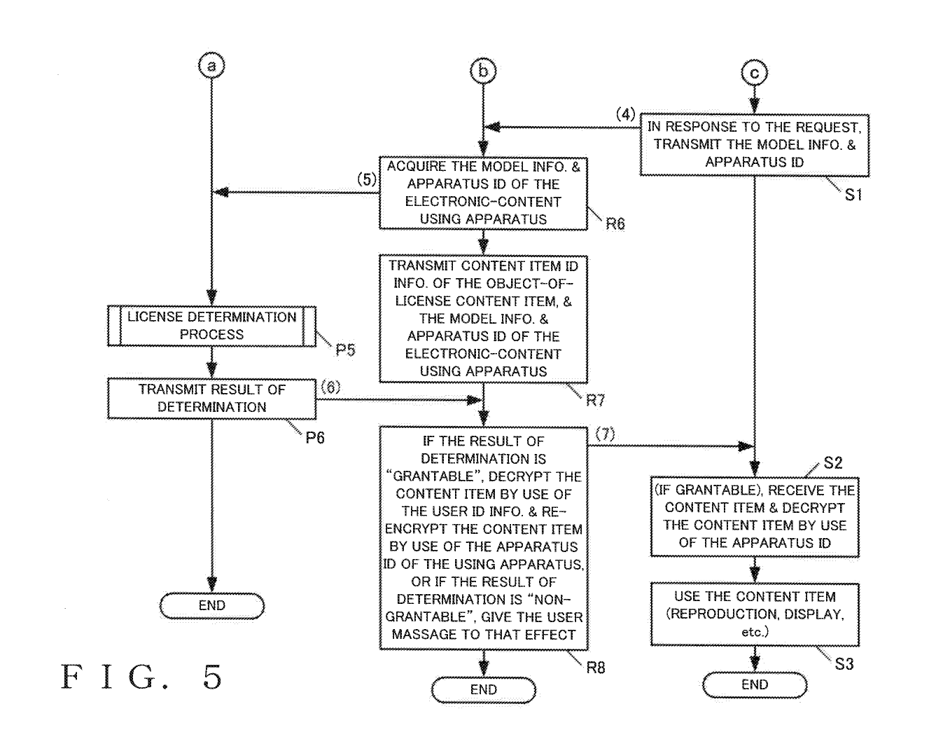

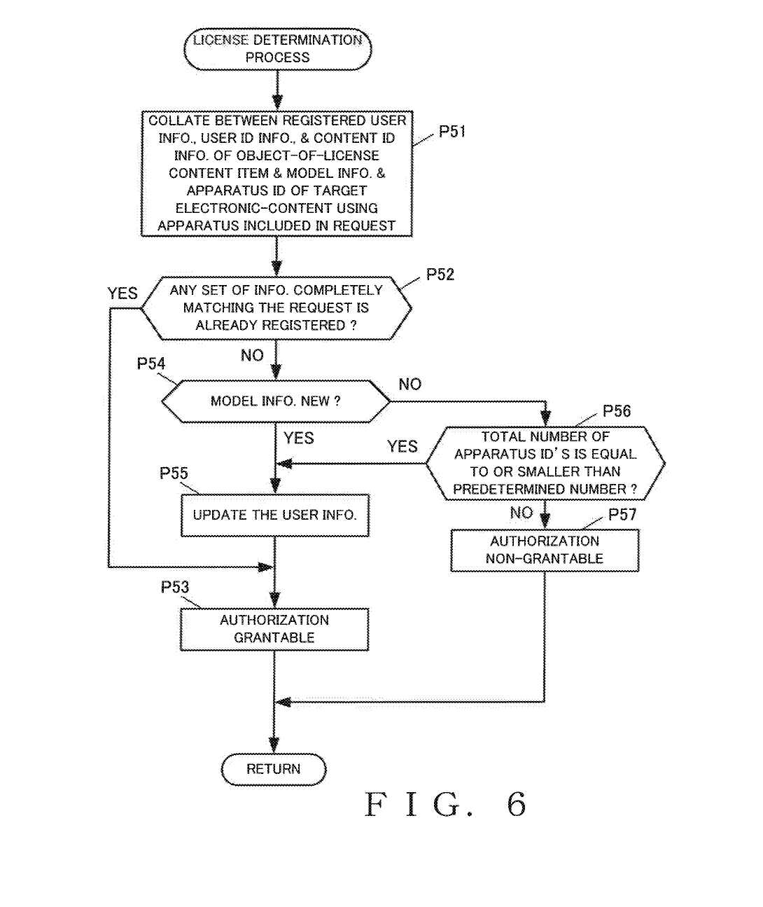

FIGS. 4 and 5 are a flow chart showing overall processing performed in the embodiment of the electronic content license system of the present invention. Reference numerals (1) to (7) in these figures correspond to procedures (1) to (7) shown in FIG. 1. Further, FIG. 6 is a flow chart showing an example operational sequence of a license determination process performed at step P55 of FIG. 5 in the embodiment of the electronic content license system.

First, at step R1 in FIG. 4, the CPU 1 of the electronic content acquisition apparatus R accesses the electronic content supply and license apparatus PQ, in response to which the CPU 1 of the supply and license apparatus PQ identifies the acquisition apparatus R at step P1 so that a state between the acquisition apparatus R and the supply and license apparatus PQ shifts to a login state (see (1)). At the time of initial or first access to the acquisition apparatus R, user identification information (user name, user ID, password, etc.) Ui indicative of a user of the acquisition apparatus R is registered as user information Us (user registration) into the user information database DBu of the license apparatus PQ, after which the user logs in. At the time of second access or after, the user only logs in by using the registered user identification information Ui.

Then, at step R2, the acquisition apparatus R sends a request to an electronic content supply section of the supply and license apparatus PQ to request the electronic content supply section to supply a certain desired content item (or object-of-license content item) Dc. Then, at step P2, the supply and license apparatus PQ receives the request from the acquisition apparatus R, and it not only retains the user identification information Ui of the acquisition apparatus R but also registers content identification information Ci corresponding to the content item Dc requested from the acquisition apparatus R (i.e., name, ID, etc. of the content item Dc) into the user information Us corresponding to the user identification information Ui of the acquisition apparatus R. Then, the supply and license apparatus PQ reads out the requested content item Dc from the electronic content database DBd and encrypts the read-out content item Dc by use of the user identification information Ui, such as the user ID, at step P3, and then transmits the encrypted content item Dc to the acquisition apparatus R at step P4 (see (2)).

At step R3, the acquisition apparatus R stores the content item Dc, received from the supply and license apparatus PQ, into the storage device 4. After that, the acquisition apparatus R creates a request for requesting the license apparatus PQ for a license or authorization to use the content item Dc, stored in the storage device 4, in a desired electronic-content using apparatus S (e.g., using apparatus Sb). At next step R4, the acquisition apparatus R receives a user operation for outputting (sending) the content item Dc to the desired electronic-content using apparatus S. Then, at step R5, the acquisition apparatus R requests the desired electronic-content using apparatus S for the model information Kd and apparatus ID of the apparatus S.

In response to the request from the acquisition apparatus R, the CPU 1 of the electronic-content using apparatus S transmits the model information Kd and apparatus ID of the apparatus S to the acquisition apparatus R at step S1 of FIG. 5 (see (4)). As noted above, in the case where information is communicated via a detachable storage medium, the model information Kd and apparatus ID of the apparatus S are written into the detachable storage medium. In this case, it is preferable that the model information Kd and apparatus ID of the apparatus S be written into the detachable storage medium after being encrypted so as not to be altered by the user.

Then, at step R6, the electronic content acquisition apparatus R retains (acquires) the model information Kd and apparatus ID, received from the electronic-content using apparatus S, into the RAM 2, If the received model information Kd and apparatus ID are in encrypted form, they are retained into the RAM 2 after being decrypted. At next step R7, the electronic content acquisition apparatus R transmits to the license apparatus PQ a request including not only the content identification information Ci, such as the content name and content ID, obtained from the content item Dc stored in the storage device 4 but also the model information Kd and apparatus ID retained in the RAM 2. Namely, the electronic content acquisition apparatus R transmits to the license apparatus PQ a request including (defining) the content identification information Ci, corresponding to the content item Dc which the user wants to use (i.e., object-of-license content item Dc), and the model information Kd and apparatus ID of the target (or request-target) using apparatus which is object-of-license equipment where the user wants to use the content item Dc (see (5)).

Upon receipt of the content identification information Ci and the model information Kd and apparatus ID transmitted from the electronic content acquisition apparatus R, the license apparatus PQ performs at step P5 the “license determination process” that will be described, later with reference to FIG. 6, and then transmits a result of the license determination to the acquisition apparatus R at step P6. Namely, the license apparatus PQ transmits to the acquisition apparatus R determination result information indicative of a result of the determination made in the license determination process of step P5 (more specifically, step P53 or P57 in FIG. 6).

At step R8, if the determination result information received from the license apparatus PQ indicates a determination result “authorization grantable”, the acquisition apparatus R outputs the desired or object-of-license content item Dc to the desired target electronic-content using apparatus S (e.g., using apparatus Sb) after re-encrypting the content item Dc so that the content item Dc can be used only in the target using apparatus S (see (7)). In the case where information is communicated via a detachable storage medium, the content item Dc is written into the detachable storage medium. If on the other hand, the determination result information received from the license apparatus PQ indicates a determination result “authorization non-grantable”, the acquisition apparatus R gives the user a message to that effect via the display section 6 and 10 or the audio output section.

If the determination result indicated by the determination result information is “authorization grantable”, the electronic-content using apparatus S goes to step S2, where it receives the content item Dc output from the acquisition apparatus R, decrypts the received content item Dc by use of the apparatus ID of the apparatus S and stores (copies) the decrypted content item Dc into the storage medium 4 or the like. Then, at step S3, the thus-stored content item Dc is used by the using apparatus S itself. If the content item Dc is performance data, performance supplementing data (such as registration data and accompaniment style data), tone color data, or the like, such data is set from the storage device 4 into a tone generator, so that tones are generated by the tone generator. If the content item Dc is ringing tone data, music data, or the like, such data is read out from the storage device 4 and audibly reproduced or sounded via an audio output section (not shown). Further, if the content item Dc is musical score data, image data, motion picture data, text data, map data, or the like, such data is read out and reproduced from the storage device 4 and displayed on the display 10. Further, if the content item Dc is an application program, the application program is loaded from the storage device 4 into the RAM 2, so that the application is executed.

Note that, if the determination result indicated by the determination result information is “authorization non-grantable”, on the other hand, the electronic-content using apparatus S cannot receive the content item Dc from the electronic content acquisition apparatus R.

[License Determination Process]

FIG. 6 is a flow chart showing an example operational sequence of the license determination process performed at step P55 of FIG. 5 in the embodiment of the electronic content license system of the present invention. At first step P51, the CPU 1 of the electronic content license apparatus PQ compares and collates between (1) sets of the user identification information Ui, content identification information Ci, model information Kd and apparatus IDs included in the user information Us registered in the user information database DBu and (2) a set of the user identification information Ui (already retained in the RAM 2 at step P2) indicative of the user of the electronic-content using apparatus R, content identification information Ci indicative of the object-of-license content item Dc, model information Kd of the target electronic-content using apparatus S (object-of-license equipment) and apparatus ID of the target electronic-content using apparatus S that are included in the request transmitted from the electronic content acquisition apparatus R requesting a license or authorization to use the content item Dc.

More specifically, first, the CPU 1 of the electronic content license apparatus PQ performs a step of comparing and collating between a pair of the user identification information Ui and content identification information Ci included in the request and pairs of the user identification information Ui and the content identification information Ci registered in the database DBu. Namely, the CPU 1 of the electronic content license apparatus PQ makes a search, from among the user identification information Ui registered in the user information database DBu, user identification information Ui matching the user identification information Ui included in the request. If the search could successfully find such user identification information Ui matching the user identification information Ui included in the request, the electronic content license apparatus PQ makes a further search, from among the content identification information Ci registered in the user information database DBu in association with the thus-found user identification information Ui, content identification information Ci matching the content identification information Ci included in the request. If it has been determined, as a result of the collation, that the pair of the user identification information Ui and content identification information Ci included in the request matches any one of the corresponding pairs of the information registered in the user information database DBu, the CPU 1 of the electronic content license apparatus PQ proceeds to a next step of comparing and collating between a pair of the model information Kd and apparatus ID in the request and pairs of the model information Kd and apparatus IDs in the user information database DBu. If it has been determined, as a result of the collation, that the user identification information Ui and content identification information Ci included in the request does not match any one of the pairs of the user identification information Ui and content identification information Ci registered in the user information database DBu, it means that the user in question is not a duly-registered user or that the electronic content in question is not a duly-purchased electronic content, and thus, the CPU 1 of the electronic content license apparatus PQ informs to that effect and brings the license determination process to an end. If it has been determined, as a result of the collation, that the user identification information Ui and content identification information Ci included in the request matches any one of the pairs of the user identification information Ui and content identification information Ci registered in the user information database DBu, the CPU 1 of the electronic content license apparatus PQ proceeds to the above-mentioned step of comparing and collating between the pair of the model information Kd and apparatus ID in the request and the pairs of the model information Kd and the apparatus IDs in the user information database DBu. In the aforementioned manner, the CPU 1 of the electronic content license apparatus PQ compares and collates between the sets of the user identification information Ui, content identification information Ci, model information Kd and apparatus IDs.

Next, at step P52, the CPU 1 of the license apparatus PQ determines whether a set of the user identification information Ui, content identification information Ci, model information Kd and apparatus ID completely matching the set of the user identification information Ui, content identification information Ci, model information Kd and apparatus ID included in the request is already registered in the user information database DBu. If there is such a set of the user identification information Ui, content identification information Ci, model information Kd and apparatus ID in the user information database DBu, it means that the set of the information included in the request transmitted from the acquisition apparatus R is a set of the user information for which an authorization to use (use license) has been granted previously, and thus, the CPU 1 of the license apparatus PQ proceeds to step S53, where it determines that an authorization to use the requested content item Dc is grantable with no problem this time as well. Then, the CPU 1 of the license apparatus PQ terminates the instant license determination process and returns to step P6 of the overall processing of FIG. 5.

If, on the other hand, it has been determined that there is no complete match between the set of the user information Us registered in the user information database MI and the set of the information included in the request transmitted from the acquisition apparatus R (e.g., it has been determined that there is no match between the sets of the model information Kd and apparatus IDs although there is a match between the sets of the user identification information and the content identification information Ci) (i.e., NO determination at step P52), the CPU 1 of the license apparatus PQ proceeds to step P54, where it determines whether the model information Kd of the target electronic-content using apparatus S. Which is the object-of-license equipment, is new, i.e. whether the model information Kd does not match any one of the existing (registered) model information Kd. Namely, the CPU 1 of the license apparatus PQ determines whether the pair of the user identification information Ui and content identification information Ci included in the request matches any one of the pairs of the user identification information Ui and content identification information Ci registered in the user information database DBu but the model information. Kd included in the request does not match any one of the model information Kd registered in the user information database DBu (and hence naturally the apparatus ID does not match any one of the registered apparatus IDs either), and whether the target electronic-content using apparatus S, which is the object-of-license equipment, is of a new model.

Here, upon determination that the model information Kd of the target (object-of-license) electronic-content using apparatus S does not match any one of the existing (registered) model information Kd and that the target electronic-content using apparatus S is of a new model (i.e., YES determination at step P54), the CPU 1 of the license apparatus PQ proceeds to step P55 to update the user information Us and then determines at next step P53 that an authorization to use the particular content Dc is grantable. Namely, if the target electronic-content using apparatus S is of a new model, this using apparatus S in which the user wants to use the particular or object-of-license content item Dc is determined to be an apparatus to which an authorization to use the particular content item Dc is grantable, because the using apparatus S is the first using apparatus S of the new model in Which the user wants to use the object-of-license content item Dc. Thus, the CPU 1 of the license apparatus PQ additionally registers the model information Kd and apparatus ID of the using apparatus S of the new model into the user information Us registered in the database DBu to thereby update the registered user information Us. After the operation of step P53, the CPU 1 of the license apparatus PQ terminates the instant license determination process and returns to step P6 of the overall processing of FIG. 5.

If the target, or object-of-license, electronic-content using apparatus S is not of a new model, i.e. the model information Kd of the object-of-license electronic-content using apparatus S matches one of the existing (registered) model information Kd (NO determination at step P54), the CPU 1 of the license apparatus PQ branches to step P56, where it is determined whether the number of the apparatus IDs of the electronic-content using apparatus S of that model is equal to or smaller than a predetermined number N (e.g., N=4). More specifically, at step P56, the CPU 1 of the license apparatus PQ checks the total number n of the registered user information of which the user identification information Ui, the content identification information Ci and the model information matches the corresponding information included in the request but only the apparatus ID does not match the apparatus ID included in the request, and it also determines whether the checked number a is equal to or smaller than the predetermined number N.

Upon determination that the total number n of different apparatus IDs is equal to or smaller than the predetermined number N (i.e., n≦N) (YES determination at step P56), the CPU 1 of the license apparatus PQ proceeds to step P55 to update the user information Us and then determines at next step P53 that an authorization to use the content item Dc is grantable to the target or object-of-license electronic-content using apparatus S, i.e. that the object-of-license electronic-content using apparatus S can be authorized to use the content item Dc. More specifically, assuming N=4 and assuming that up to five using apparatus S of the same user (Ui), same electronic content Dc and same model (Kd) as the registered user information Us can be authorized to use the object-of-license electronic content, the CPU 1 of the license apparatus PQ determines, at step P56, whether the number of the apparatus IDs, having so far been registered in the user information US of which the user identification information Ui, the content identification information Ci and the model information Kd identical in value to the corresponding information included in the request, is equal to or smaller than four. If the number of the apparatus IDs is equal to or smaller than four (YES determination at step P56), the CPU 1 determines that the object-of-license using apparatus S can be authorized to use the content item Dc, and thus the CPU 1 additionally registers the model information Kd and apparatus ID of the object-of-license using apparatus S into the user information Us registered in the database DBu to thereby update the registered user information Us. Then, after the operation of step P55, the CPU 1 of the license apparatus PQ terminates the instant license determination process and returns to step P6 of the overall processing of FIG. 5.

If the total number n of different apparatus IDs has reached a maximum number (e.g., “five”), on the other hand, it is determined the total number n is not equal to or smaller than the predetermined number N (i.e., n>N) (NO determination at step P56), the CPU 1 of the license apparatus PQ proceeds to step P57, where it determines that the object-of-license electronic-content using apparatus S cannot be authorized to use the content item Dc. Namely, if the maximum number of apparatus IDs (e.g., five apparatus IDs) have already been registered for the using apparatus S of the same user (Ui), same electronic content Dc and same model (Kd) as the registered user information Us, no more using apparatus S can be authorized to use the content item Dc. Then, the CPU 1 of the license apparatus PQ terminates the instant license determination process and returns to step P6 of the overall processing of FIG. 5.

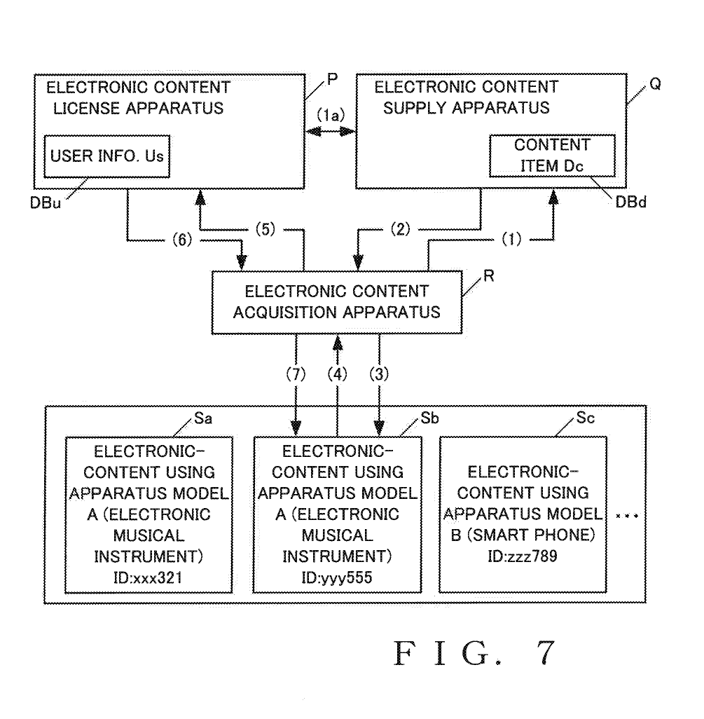

### Construction of Other Embodiment of the System

Whereas the foregoing have described, with primary reference to FIG. 1, the electronic content license system where the electronic content license apparatus functions also as the electronic content supply apparatus, the electronic content license apparatus and the electronic content supply apparatus may be provided as separate apparatus. FIG. 7 is a block diagram explanatory of an example construction of such an other or second embodiment of the electronic content license system of the present invention. As shown, the second embodiment of the electronic content license system comprises: an electronic content license apparatus (hereinafter also referred to simply as “license apparatus”) P; an electronic content supply apparatus (hereinafter also referred to simply as “supply apparatus”) Q; an electronic content acquisition apparatus R; and a plurality of electronic-content using apparatus Sa, Sb, Sc, . . . . The electronic content supply apparatus Q includes the electronic content database DBd cumulatively storing and managing a plurality of content items Dc, and thus, it functions as an electronic content selling server that supplies a content item Dc to a client. The electronic content license apparatus P includes the user information database DBu cumulatively storing and managing individual user information Us.

The electronic content license apparatus P, the electronic content supply apparatus Q and the electronic content acquisition apparatus R can communicate with one another in a wired or wireless fashion. The electronic content supply apparatus Q has a function of transmitting to the electronic content acquisition apparatus R a content item Dc requested from the content acquisition apparatus R. The electronic content license apparatus P has a function of determining whether or not to grant a license or authorization regarding use of a content item Dc transmitted from the supply apparatus Q to the acquisition apparatus R. For such a purpose, the user information database DBu has stored therein user information Us as set forth above. Further, relationship of the electronic content acquisition apparatus R and the electronic-content using apparatus Sa, Sb, Sc, . . . with users, constructions and functions of the electronic content acquisition apparatus R and the electronic-content using apparatus Sa, Sb, Sc, . . . , types of content items Dc handled in the electronic content license system, etc, are similar to those described above in relation to the first embodiment and thus will not be described here to avoid unnecessary duplication.

The second embodiment of the electronic content license system operates in accordance with the same procedures (1) to (7) as the first embodiment of FIG. 1 (hereinafter referred to as “first system”). In the second embodiment, the electronic content license apparatus P and the electronic content supply apparatus Q may be constructed to share the user information database DBu and the electronic content database DBd, through information exchanges (1a) and (6a), so that the two apparatus P and Q can, for example, know which user uses what kind of content item Dc in which electronic-content using apparatus R (identified by model information Kd and apparatus ID). If a desired content item Dc which a user (e.g., user A) wants to purchase is supplied to the electronic content acquisition apparatus R, and once it is determined, with reference to the user information database DBu of the electronic content supply apparatus Q, that a predetermined condition is satisfied, a license or authorization to use the supplied content item Dc is granted such that the supplied content item Dc can be used in a predetermined electronic-content using apparatus S (e.g., electronic-content using apparatus Sb). The following describe behavior of the second embodiment of the electronic content license system of the present invention while omitting description about the same features as in the first system.

(1) The user (e.g., user A) performs an operation for accessing the electronic content supply apparatus Q via the electronic content acquisition apparatus R. The electronic content acquisition apparatus R transmits user identification information indicative of the user to the electronic content supply apparatus Q, so that the supply apparatus Q inputs the user identification information to a user registration area in the electronic, content database DBd to thereby register the user. Then, a content item Dc to be purchased Dc is specified and a purchase process of the specified content item Dc is performed via the electronic content acquisition apparatus R. Then, the electronic supply apparatus Q records content identification information, such as a name and ID, of the specified content item Dc into the user registration area and thereby registers that the user has duly purchased the content item Dc.

(1a) The electronic supply apparatus Q transmits to the electronic content license apparatus P the user identification information Ui and content identification information Ci registered in the user registration area. Then, the electronic content license apparatus P registers into the user information database DBu the user identification information Ui and content identification information Ci transmitted from the electronic supply apparatus Q.

(2) Then, the electronic content supply apparatus Q encrypts the content item Dc by use of the user identification information Ui and transmits the thus-encrypted content item Dc to the electronic content acquisition apparatus R. Then, the electronic content acquisition apparatus R receives and acquires the content item Dc and stores the acquired content item Dc into the storage device 4.

(3) to (6) here are the same as (3) to (6) described above in relation to the first system, except that the “license apparatus RQ” in the first system should be replaced with “license apparatus P”.

(7) here is the same as (7) described above in relation to the first system, except that the “license apparatus RQ” in the first system should be replaced with “license apparatus P”.

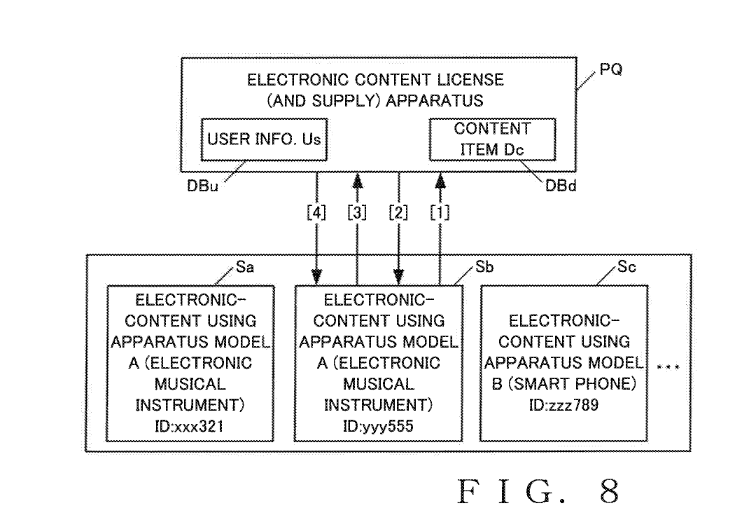

### Construction of Still Other Embodiment of the System

Whereas the foregoing have described, with primary reference to FIGS. 1 and 7, the embodiments of the electronic content license system where the electronic content acquisition apparatus intervenes between the electronic content supply apparatus or the electronic content license apparatus and the individual electronic-content using apparatus, each of the electronic-content using apparatus may be constructed to communicate information directly with the electronic content supply apparatus or the electronic content license apparatus for acquiring a desired content item and obtaining a license or authorization to use the desired content item. FIG. 8 is a block diagram explanatory of an example construction of such a still other or third embodiment of the electronic content license system of the present invention. In the third embodiment of the electronic content license system, each of the electronic-content using apparatus S (Sa, Sb, Sc, . . . ) itself communicates information with the electronic content supply and license apparatus PQ without intervention of the electronic content acquisition apparatus, and thus, flows of information are slightly different from those in the embodiments of FIGS. 1 and 7. The system of FIG. 8 behaves in accordance with procedures [1] to [4] to be described below.

[1] A user (e.g., user A) accesses the electronic content supply and license apparatus PQ, via the electronic-content using apparatus S (e.g., using apparatus Sb), to register the user identification information Ui, such as the user ID, into the user information database DBu as the user information Us. Then, the user purchases a desired content item Dc and additionally writes content identification information Ci indicative of the purchased content item Dc into the user information Us. Note that such registration of the user information Us and additional writing of the content identification information Ci may be performed via an electronic content acquisition apparatus (e.g., personal computer) separate from the using apparatus S as in the above-described embodiments.

[2] The electronic content license apparatus PQ encrypts the content item Dc by use of the user identification information Ui, such as the user ID, and transmits the encrypted content item Dc to the electronic-content using apparatus S, so that the using apparatus S stores the content item Dc into the storage device 4.

[3] The electronic-content using apparatus S transmits to the electronic content license apparatus PQ a request defining a set of the user identification information Ui, such as the user ID, content identification information indicative of the purchased content item Dc and model information Kd and apparatus ID of the using apparatus S, to thereby request a license or authorization to use the purchased content item Dc in the using apparatus S.

[4] In response to receipt of the request from the electronic-content using apparatus S, the electronic content license apparatus PQ performs the license determination process as in the above-described embodiments and then transmits to the using apparatus S determination result information indicative of a result of the determination as to whether an authorization to use the content item Dc requested from the electronic-content using apparatus S is grantable or not. If the determination result information indicates that the requested authorization to use the content item Dc is grantable, the electronic-content using apparatus S decrypts the content item Dc by use of the user identification information Ui, such as the user ID. The thus-decrypted content item Dc is used for reproduction and display on the using apparatus S. If the determination result information indicates that the requested authorization to use the content item Dc is non-grantable, on the other hand, a message to that effect is notified to the user via the display section 6 and 10 an/or the audio output section.

When the user wants to acquire the desired content item Dc from the electronic content license apparatus PQ via the second or subsequent electronic-content using apparatus S (e.g., using apparatus Sa), the user can acquire the desired content item Dc free of charge by just sending the user information Us to the electronic content license apparatus PQ. Then, the license determination process is performed as in the above-described embodiments, and if the determination result information indicates that the requested authorization to use the content item Dc is grantable, the electronic-content using apparatus S (e.g., Sa) uses the content item Dc in a similar manner to the aforementioned. If the determination result information indicates that the requested use license is non-grantable, on the other hand, a message to that effect is output to the user

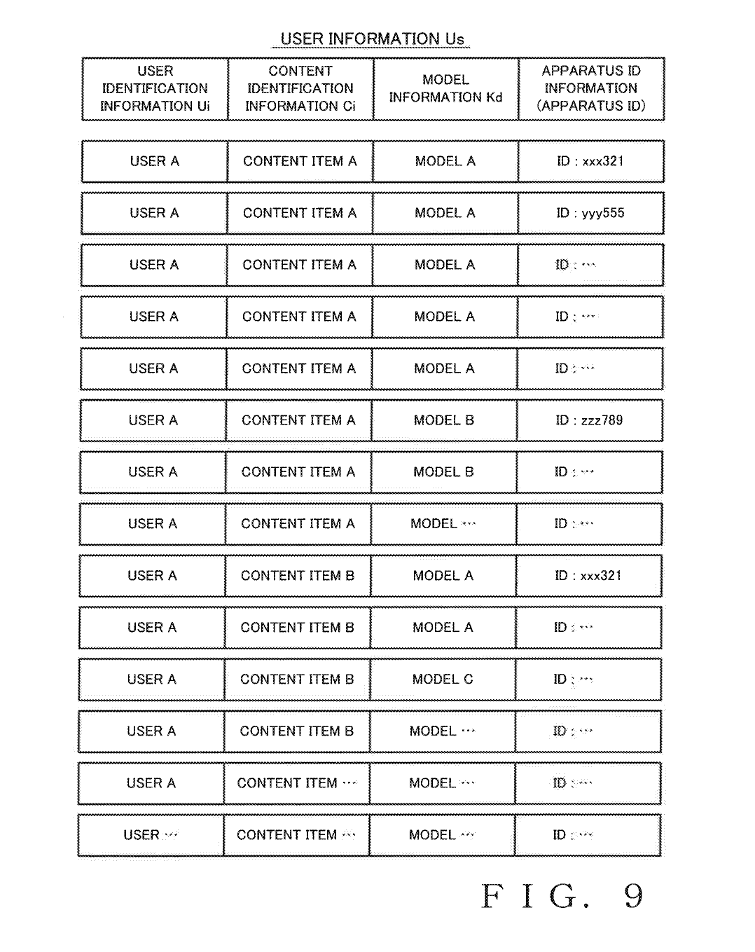

As an alternative, procedures [1] and [3] may be performed simultaneously and procedures [2] and [4] may be performed simultaneously so that the model information Kd and the apparatus ID are notified, simultaneously with the purchase of the content item Dc, to the electronic content license apparatus PQ to allow the license apparatus PQ to determine whether a license or authorization to use the content item Dc is grantable or not. If the authorization is grantable, the electronic content license apparatus PQ permits the electronic-content using apparatus S to acquire the content item Dc, while, if the authorization is non-grantable, the electronic content license apparatus PQ does not permit the electronic-content using apparatus S to acquire the content item Dc.

[Other Form of Storage of the User Information]

Whereas FIG. 3 shows the form of storage of the user information Us in which, per user (user identification information Ui), the content identification Ci, the model information Kd and the apparatus ID are stored in association with one another, the present invention is not so limited, and any other desired form of storage of the user information Us may be employed as long as the user identification information Ui, the content identification Ci, the model information Kd and the apparatus ID are stored in association with one another. FIG. 9 is a conceptual diagram explanatory of an alternative form of storage of the user information Us. According to this alternative form of storage of the user information Us, a multiplicity of records, each comprising a set of user identification information Ui, content identification Ci, model information Kd and an apparatus ID stored in association with one another, are stored in the user information database DBu, as show in FIG. 9.

This application is based on, and claims priority to, JP PA 2013-199074 filed on 25 Sep. 2013. The disclosure of the priority application, in its entirety, including the drawings, claims, and the specification thereof, are incorporated herein by reference.

What is claimed is:

1. An apparatus for managing an electronic content license, comprising:
a user information storage device which stores therein, as user information and for each of a plurality of users having acquired one or more content items, user identification information identifying the user, content identification information indicative of the one or more content items acquired by the user, model information indicating, for each of the one or more content items, models of one or more electronic-content using apparatus having been granted an authorization to use the content item, and apparatus IDs individually identifying the one or more electronic-content using apparatus, in association with one another; and
a processor unit configured to:
receive from a user a request requesting an authorization to use a particular content item, the request defining user identification information identifying the requesting user, content identification information indicative of the particular content item, model information indicative of a model of a target electronic-content using apparatus where the user wants to use the particular content item and apparatus ID of the target electronic-content using apparatus;
compare the information defined by the request with the user information stored in said user information storage device and thereby identify from among the user information stored in said user information storage device, particular user information of which the user identification information, the content identification information and the model information matches the request but the apparatus ID does not match the request; and
if a number of the apparatus IDs associated with the identified particular user information is equal to or smaller than a predetermined number, authorize use of the particular content item in the target electronic-content using apparatus.

2. The apparatus as claimed in claim 1, wherein said processor unit is further configured to, in response to authorizing the use of the particular content item, update said user information storage device so as to associate the apparatus ID of the target electronic-content using apparatus with the identified user information.

3. The apparatus as claimed in claim 1, wherein said processor unit is further configured to, in response to identifying, from among the user information stored in said user information storage device, particular user information of which the user identification information and the content identification information matches the request but the model information does not match the request, granting an authorization to use the particular content item in the target electronic-content using apparatus.

4. The apparatus as claimed in claim 3, wherein said processor unit is further configured to, in response to granting the authorization to use the particular content item, update said user information storage device so as to associate the model information and the apparatus ID, defined by the request, with the identified user information.

5. The apparatus as claimed in claim 1, wherein said processor unit is further configured to receive, from another user apparatus than the target electronic-content using apparatus, the request requesting the authorization to use the particular content item, and
wherein the target electronic-content using apparatus and the user apparatus are capable of communicating with each other, and the user apparatus is configured to acquire the model information and the apparatus ID from the target electronic-content using apparatus and transmit the acquired model information and apparatus ID to said processor unit.

6. The apparatus as claimed in claim 1, which further comprises a content database that stores therein a plurality of content items, and
wherein, a content item corresponding to the content identification information defined by the request is retrieved from said content database, so that the retrieved content item is sent to the user.

7. A system comprising:
at least one electronic-content using apparatus; and
an apparatus for managing an electronic content license comprising:
a user information storage device which stores therein, for each of a plurality of users having acquired one or more content items, user identification information identifying the user, content identification information indicative of the one or more content items acquired by the user, model information indicating, for each of the one or more content items, models of one or more electronic-content using apparatus having been granted an authorization to use the content item, and apparatus IDs individually identifying the one or more electronic-content using apparatus, in association with one another and as user information of the user; and
a processor unit configured to:
receive from a user of the at least one electronic-content using apparatus a request requesting an authorization to use a particular content item, the request defining user identification information identifying the requesting user, content identification information indicative of the particular content item, model information indicative of a model of the at least one electronic-content using apparatus where the user wants to use the particular content item and apparatus ID of the at least one electronic-content using apparatus;
compare the information defined by the request with the user information stored in said user information storage device and thereby identify, from among the user information stored in said user information storage device, particular user information of which the user identification information, the content identification information and the model information matches the request but the apparatus ID does not match the request; and
if a number of the apparatus IDs associated with the identified particular user information is equal to or smaller than a predetermined number, authorize use of the particular content item in the at least one electronic-content using apparatus,
wherein the at least one electronic-content using apparatus can use the particular content item on condition that an authorization to use the particular content item is granted in response to the request.

8. A method for managing an electronic content license based on a user information storage device, the user information storage device storing therein, for each of a plurality of users having acquired one or more content items, user identification information identifying the user, content identification information indicative of the one or more content items acquired by the user, model information indicating, for each of the one or more content items, models of one or more electronic-content using apparatus having been granted an authorization to use the content item, and apparatus IDs individually identifying the one or more electronic-content using apparatus, in association with one another and as user information of the user, said method comprising:
a step of a processor unit receiving from a user a request requesting an authorization to use a particular content item, the request defining user identification information identifying the requesting user, content identification information indicative of the particular content item, model information indicative of a model of a target electronic-content using apparatus where the user wants to use the particular content item and apparatus ID of the target electronic-content using apparatus;
a step of the processor unit comparing the information defined by the request with the user information stored in the user information storage device and thereby identifying, from among the user information stored in the user information storage device, particular user information of which the user identification information, the content identification information and the model information matches the request but the apparatus ID does not match the request; and
a step of, if a number of the apparatus IDs associated with the identified particular user information is equal to or smaller than a predetermined number, the processor unit authorizing use of the particular content item in the target electronic-content using apparatus.

9. A non-transitory computer-readable storage medium containing instructions executable by a processor unit for performing a method for managing an electronic content license based on a user information storage device, the user information storage device storing therein, for each of a plurality of users having acquired one or more content items, user identification information identifying the user, content identification information indicative of the one or more content items acquired by the user, model information indicating, for each of the one or more content items, models of one or more electronic-content using apparatus having been granted an authorization to use the content item, and apparatus IDs individually identifying the one or more electronic-content using apparatus, in association with one another and as user information of the user, said method comprising:
a step of receiving from a user a request requesting an authorization to use a particular content item, the request defining user identification information identifying the requesting user, content identification information indicative of the particular content item, model information indicative of a model of a target electronic-content using apparatus where the user wants to use the particular content item and apparatus ID of the target electronic-content using apparatus;
a step of comparing the information defined by the request with the user information stored in the user information storage device and thereby identifying, from among the user information stored in the user information storage device, particular user information of which the user identification information, the content identification information and the model information matches the request but the apparatus ID does not match the request; and
a step of, if a number of the apparatus IDs associated with the identified particular user information is equal to or smaller than a predetermined number, authorizing use of the particular content item in the target electronic-content using apparatus.
